(19) United States
(12) Patent Application Publication
(10) Pub. No.: US 2008/0002679 A1
(43) Pub. Date: Jan. 3, 2008

(54) METHODS AND ARRANGEMENTS TO NEGOTIATE COMMUNICATION SPEED

(76) Inventors: Robert A. Dunstan, Forest Grove, OR (US); Tom Slaight, Beaverton, OR (US); Dale Stolitzka, Los Altos, CA (US)

Correspondence Address: SCHUBERT, OSTERRIEDER & NICKELSON, PLLC;c/o Intellevate, P.O. BOX 52050, MINNEAPOLIS, MN, 55402, US

(21) Appl. No.: 11/428,339

(22) Filed: Jun. 30, 2006

(51) Int. Cl. H04L 12/56

(52) U.S. Cl. 370/389

(57) ABSTRACT

Methods and arrangements to negotiate a bit rate for a message of a communication on a multiple client communication medium such as a bus are disclosed. Embodiments may comprise a host for medium management and one or more client devices coupled with a communication medium. The host and/or one or more of the client devices may comprise devices capable of originating communications across the communication medium, also referred to as originating devices. Furthermore, the host and/or one or more of the clients may comprise devices capable of receiving communications via the communication medium, also referred to as receiving devices. Upon selecting a first bit rate, the originating device may transmit an address associated with one or more receiving devices that are the target of a communication. The originating device may then negotiate a second bit rate with the receiving device(s) to facilitate transmission of a message of the communication.

### FIELD

The present invention is in the field of communications between devices. More particularly, the present invention relates to methods and arrangements to negotiate communication speed between devices.

### BACKGROUND

Data buses are found in virtually all computers and processor-based devices to facilitate communication between various components. For instance, data buses may facilitate communications between a processor and random access memory, other application-specific integrated circuits (ASICs), and peripheral devices. While some buses require complex logic for coordination, high speeds and multiple wires for mass data transfers, other data buses are single wire, low-speed buses with relatively simple logic. Single-wire data buses avoid many issues faced by more complex buses such as multiple traces, multiple pins and a high gate count, making such buses significantly less costly in terms hardware and space requirements.

Several two-wire buses, such as the 12C bus developed by Philips Electronics N.V., which support communication between multiple devices use a wired-or technique. In many of such configurations, the bus is held high by a pull-up resistor or transistor. When a device wishes to use the bus for communication, the device drives the bus at a low bit rate designed to facilitate communications with the slowest devices that may be on the bus.

In many situations, however, devices operating on the same bus may be capable of operating at significantly different speeds. When the originating device drives the bus low to initiate a communication, the originating device selects the low bit rate to ensure that the receiving (client) device can recognize the address associated with the communication. Once the bit rate is selected and the address is driven onto the bus, the receiving device recognizes the address and receives the message portion of the communication from the originating device at the same low bit rate even if the receiving device and the originating device are both capable of a higher bit rate. For example, assume that the slowest client device on the bus is capable of communicating at 10 Kbps (Kilobits per second), or 100 μs/bit (microseconds per bit), and the fastest at 1 Mbps (Megabit per second), or 1 μs per bit (microsecond per bit). The low bit rate may be 10 Kbps and, if the message is 10 bytes long, and the devices use an 8-bit address, the communication takes a total of 88 bit times (at 100 μs per bit) or 8.8 ms (milliseconds). Whereas the fastest device could potentially communicate at 88 bit times at 1 μs per bit or 0.088 ms. Speed negotiation mechanisms support a mix of different device speeds on a shared bus to enable communication with slow devices but currently sacrifice performance when communicating with fast devices.

### BRIEF DESCRIPTION OF THE DRAWINGS

Aspects of the invention will become apparent upon reading the following detailed description and upon reference to the accompanying drawings in which like references may indicate similar elements:

FIG. 1 depicts an embodiment of a system including a processor, temperature sensor, voltage sensor, and a microcontroller coupled via a single-wire bus;

FIG. 2 depicts an embodiment of a timing diagram of a communication on a multiple-client bus such as the single-wire bus of FIG. 1;

FIG. 3 depicts an embodiment of a detailed timing diagram of bit rate negotiation for a message between an originating device and a receiving device;

FIG. 4 depicts an embodiment of originating and receiving devices with logic to negotiate bit rates for transmission of an address and a message;

FIG. 5 depicts a flowchart of an embodiment for an originating device to negotiate a message bit rate with a one or more receiving devices; and

FIG. 6 depicts a flowchart of an embodiment for a receiving device to negotiate a message bit rate with an originating device.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to negotiate a bit rate for a message of a communication on a multiple client communication medium such as a bus are contemplated. Embodiments may comprise a host for medium management and one or more client devices coupled with a communication medium. The host and/or one or more of the client devices may comprise devices capable of originating communications across the communication medium, also referred to as originating devices. Furthermore, the host and/or one or more of the clients may comprise devices capable of receiving communications via the communication medium, also referred to as receiving devices. In many embodiments, the communication medium may be a single-wire bus such as a simple serial transport (SST) bus or the like.

In one embodiment, the originating device negotiates with the potential receiving devices to determine a first bit rate to transmit a communication. The communication may comprise an address associated with one or more receiving devices that are the target of the communication and a message to transmit to the addressed receiving devices. Note that in some embodiments, the address may specifically identify a client device, while in further embodiments, the address may identify a sub-group of devices, one or more specified types of devices, or a class of devices such as faster devices, newer devices, slower devices, older devices, devices within an address range, or the like. In still other embodiments, the address may identify a device that is not the target of the communication rather than affirmatively identify a device that is the target of the communication.

Upon selecting a first bit rate, the originating device may transmit the address. The originating device may then negotiate a second bit rate with the addressed receiving device(s) to facilitate transmission of the message. In many embodiments, the originating device may transmit a message rate signal indicative of the fastest rate at which the originating device is capable of transmitting the message and then monitor the bus for a response from the addressed receiving device(s).

One or more of the addressed receiving device(s) may respond with an indication of a different bit rate. In several embodiments, the addressed receiving devices respond by extending the length of time at which a logic bit level (such as a voltage level, light intensity, or other signal amplitude) is maintained on the bus to create a modified message rate signal. In such embodiments, the addressed receiving device(s) may indicate the fastest bit rate at which they are capable of receiving the message. The slowest bit rate indicated thereby extends the logic bit level for the longest duration and the originating device can select a message bit rate based upon that longest duration. In some embodiments, the application of the logic bit level on the bus by the originating device and receiving device(s) may be applied via a wired-or connection to the same wire and may be substantially simultaneous.

To illustrate, assume that the slowest client device on the bus is capable of communicating at 10 Kbps (Kilobits per second), or 100 μs/bit (microseconds per bit), and the fastest at 1 Mbps (Megabit per second), or 1 μs per bit (microsecond per bit). The negotiated bit rate may be 10 Kbps and, if the message is 10 bytes long, the devices use an 8-bit address, and that the timing negotiation takes one bit time, the communication takes a total of 89 bit times (at 100 μs per bit) or 8.9 ms (milliseconds). When targeted for the transaction, the fast client device can re-negotiate the speed after transmission of the 8-bit address. So the communication, for instance, may take 90 bit times; 9 bits at the 10 Kbps rate (1 bit for address timing negotiation and 8 bits for the address) and the remaining 81 bits at the 1 Mbps rate for a total of 981 μs.

While portions of the following detailed discussion describes embodiments with reference to specific configurations and protocols, persons of ordinary skill in the art will recognize that embodiments may be implemented with other configurations and other protocols.

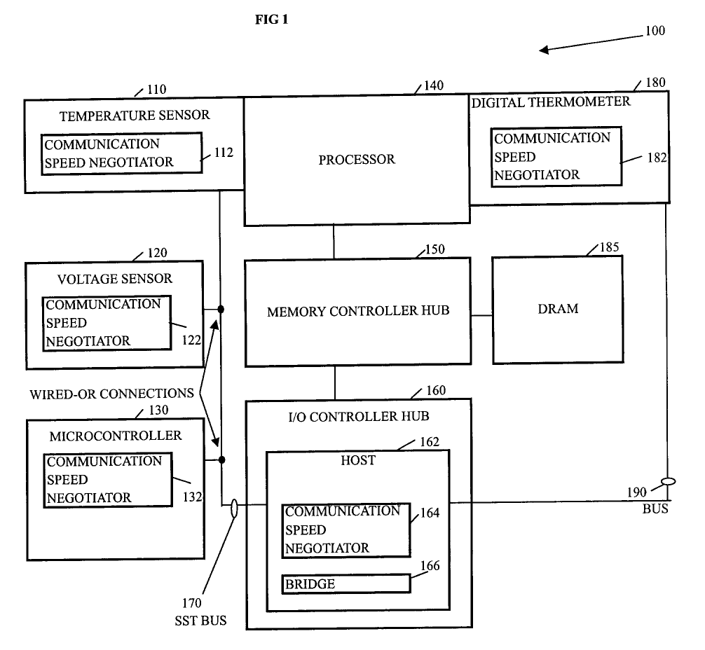

Turning now to the drawings, FIG. 1 illustrates an embodiment of a system 100. System 100 is a computer system such as a personal computer, a laptop, a workstation, or a server. Similar embodiments are implemented as, e.g., a portable music player, a portable video player, a smartphone or other cellular phone, a digital video camera, a digital still camera, a personal digital assistant (PDA), an external storage device, or the like. Further embodiments implement larger scale server configurations such as server systems that implement a system management bus (SMBus). In such embodiments, a microcontroller such as microcontroller 130 may serve as a simple serial transport (SST) host and SMBus-to-SST bridge.

System 100 comprises a processor 140, a memory controller hub 150 coupled with dynamic random access memory (DRAM) 185, and an input-output (I/O) controller hub 160. Processor 140 represents one or more processors for a system such as Intel®'s Pentium® processors, Xeong processors, Itanium® processors, Celeron® processors, or the like. Memory controller hub 150 and I/O controller hub 160 represent a chipset such as Intel®s 975X Express Chipset, 865P Chipset, 845G Chipset, 855GM Chipset, E7525 Chipset, E8870 Chipset, 852GME Chipset, 537EP Chipset, 854 Chipset, or the like. DRAM 185 may be system memory supporting execution of instructions by processor 140 by storing data and instructions related to applications and other code.

In the present embodiment, I/O controller hub 160 supports client devices on SST bus 170 and bus 190, which are single-wire buses. The client devices include devices such as a temperature sensor 110, a voltage sensor 120, microcontroller 130, and a digital thermometer 180. More specifically, I/O controller hub 160 comprises a host 162 that manages and bridges communications between SST bus 170 and bus 190. In some embodiments, I/O controller hub 160 may comprise separate hosts for SST bus 170 and bus 190 with or without a bridge 166, and, in other embodiments, I/O controller hub 160 may comprise only a host for SST bus 170 or bus 190. In further embodiments, one or both of the bus hosts and/or bridge 166 may be embodied in separate integrated chip package(s).

Host 162 may function as an originating device, a device that initiates communications, and a receiving device, a device that responds to communications initiated by other devices. For example, host 162 may initiate a reset address “ResetAddress( )” command to temperature sensor 110, voltage sensor 120, microcontroller 130, and, in some embodiments, digital thermometer 180 to reset the addresses of all dynamically addressable client devices. Dynamically addressable client devices will reset to a default address in response to a ResetAddress( ) command in preparation for an address resolution protocol (ARP). An ARP assigns addresses to the dynamically addressable client devices. A ResetAddress( ) command may be initiated upon power up of, e.g., SST bus 170, or may be initiated in response to a perceived address conflict between client devices on the bus.

When acting as an originating device, host 162 may negotiate an address transmission bit rate for buses 170 and 190. In some embodiments, the negotiation may involve raising the voltage on the bus to a high voltage level for one-fourth of a bit rate period at an achievable bit rate determined by host 162. The achievable bit rate may be the fastest bit rate that host 162 can achieve on both SST bus 170 and bus 190 at the time the communication is being initiated.

If a client device such as microcontroller 130 is unable to operate at the achievable bit rate, microcontroller 130 may extend the time period for which the high voltage level on SST bus 170 is held to indicate a slower bit rate. Microcontroller 130 may extend the time period of the high voltage to one-fourth of a bit rate period for the slower bit rate. In further embodiments, client devices such as temperature sensor 110, voltage sensor 120, microcontroller 130, and digital thermometer 180 may responsively apply a high voltage to, or otherwise maintain the high voltage on, their corresponding SST bus 170 and bus 190 for a period of time that is indicative of their respective, achievable bit rates.

Host 162 may monitor SST bus 170 and bus 190 to determine the slowest indicated bit rate and then, because the ResetAddress( ) command is targeted at all client devices, transmit the ResetAddress( ) command to all the client devices at that slowest bit rate. In several embodiments, host 162 may go through an additional negotiation for message speed.

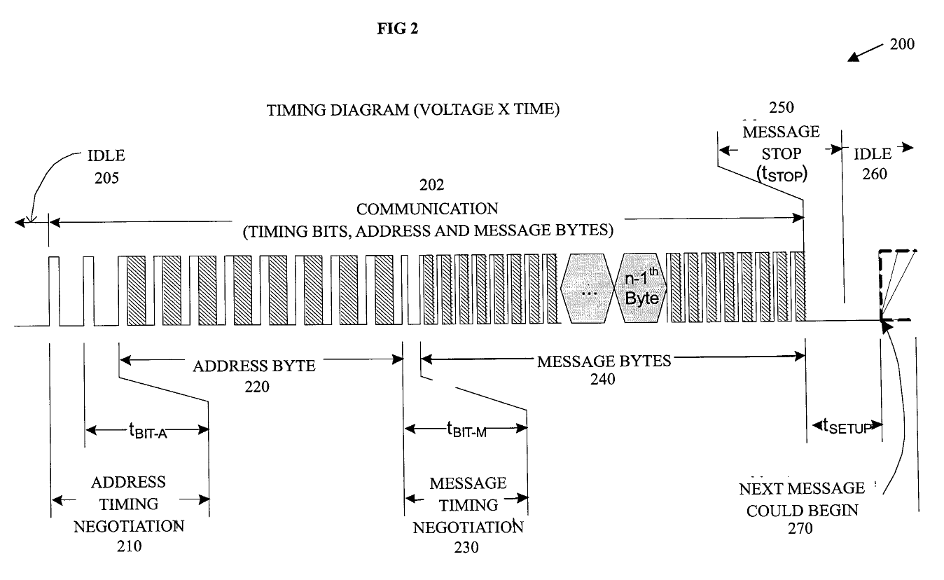

Host 162 may comprise a communication speed negotiator 164 and bridge 166. Communication speed negotiator 164 may attempt to maximize bit rates for communications addressed to and initiated by host 162. In the present embodiment, communication speed negotiator 164 may first negotiate a maximum achievable bit rate for transmission of an address for one or more client devices and, second, negotiate a maximum achievable bit rate for transmission of a message of the communication. FIG. 2 depicts an embodiment of a timing diagram 200 of a communication 202 on a multiple-client bus such as the SST bus 170 and/or bus 190 of FIG. 1.

Referring now to FIGS. 1 and 2, communication speed negotiator 164 may pull SST bus 170 and bus 190 low for an idle period 205, determine an achievable bit rate for host 162, and then initiate address timing negotiation 210 by pulling SST bus high for a period equal to one-fourth of an achievable bit rate period. In many embodiments, pulling SST bus 170 and bus 190 high for one-fourth of the achievable bit rate period and low for three fourths of the achievable bit rate period represents a logical bit such as a logical zero. In several of these embodiments, pulling the SST bus 170 and bus 190 high for three fourths of a bit rate period and low for the remainder of the period may represent, e.g. a logical one.

For communication 202, address timing negotiation 210 involves two repetitions of pulling SST bus 170 and bus 190 high and then low. First, SST bus 170 and bus 190 may be pulled high for one-fourth of the achievable bit rate period plus extensions maintained by client devices that can respond quickly enough and low for three fourths of the achievable bit rate period plus the extensions. Second, SST bus 170 and bus 190 may be pulled high and maintained high in a similar manner for one-fourth of the address bit rate period, t_{BIT-A}, because all client devices should be capable of responding and pulled low for three fourths of the address bit rate period, t_{BIT-A}. For instance, a client device that utilizes a phase-locked loop may not be able to respond fast enough, if at all, during the first bit rate period. In other embodiments, address timing negotiation 210 may be somewhere in a range from less than one bit rate period to multiple bit rate periods. Furthermore the duration of address timing negotiation 210 may be based upon a default, pre-selected, or previously-utilized bit rate period rather than the currently achievable bit rate period.

The originating device such as host 162 may determine the address bit rate period, t_{BIT-A}, and pull the bus low for three-fourths of the address bit rate period, t_{BIT-A}. In further embodiments, address timing negotiation 210 may vary in length based upon the responsiveness of client devices.

If no client device opposes the achievable bit rate indicated by host 162, then host 162 may not detect an extension of the high voltage level on SST bus 170 or bus 190 during address timing negotiation 210. On the other hand, if, e.g., microcontroller 130 indicates a different bit rate by, e.g., extending the length of time for which SST bus 170 and bus 190 is held high, communication speed negotiator 164 may calculate or otherwise determine the achievable bit rate set forth by microcontroller 130 based upon the length of the extension.

After address timing negotiation 210, in the present embodiment, host 162 has a current indication of the maximum bit rate achievable by all client devices on SST bus 170 and/or bus 190. Host 162 then transmits the address byte 220 across SST bus 170 and/or bus 190 at the negotiated bit rate so each client device can determine whether or not the communication 202 is directed toward it. For instance, if the address byte 220 comprises an address for temperature sensor 110, the other client devices (voltage sensor 120, microcontroller 130, and digital thermometer 180) may ignore the remainder of communication 202. However, temperature sensor 110 may be capable of communicating at a bit rate that is higher than the negotiated bit rate determined for transmission of address byte 220. Thus, communication 202 includes a message timing negotiation 230.

Message timing negotiation 230 may involve raising the voltage on SST bus 170 and bus 190 to a high voltage level by the message originating device, e.g., host 162, for one-fourth of an achievable bit rate period. In such embodiments, after temperature sensor 110 decodes address byte 220 to determine that the address byte 220 indicates that temperature sensor 110 is the targeted client device, communication speed negotiator 112 of temperature sensor 110 may determine the current, achievable bit rate of temperature sensor 110 and indicate the achievable bit rate via SST bus 170 by holding the logic bit level on SST bus 170 for, e.g., one-fourth of the achievable bit rate period. Communication speed negotiator 164 may then determine a bit rate for message bytes 240 based upon that achievable bit rate if that achievable bit rate is equivalent to or slower than the achievable bit rate indicated by the message originating device. For example, communication speed negotiator 164 may drive SST bus 170 to a logic bit level for 25% of its fastest bit rate. Communication speed negotiator 112 may not respond if temperature sensor 110 will accept any speed proposed by host 162 or may respond with an indication of the same or a slower bit rate (the achievable bit rate for temperature sensor 110) by extending the amount of time the logic bit level is held on SST bus 170. In the latter case, communication speed negotiator 164 will measure the amount of time the logic bit level remains on SST bus 170 and will drive SST bus 170 low for three times that amount of time. Communication speed negotiator 112 measures the total length of time, t_{BIT-M}, from the initial transition to the logic bit level to the subsequent transition to the logic bit level to determine the bit rate indicated by host 162.

On the other hand, if host 162 is not capable of the achievable bit rate of temperature sensor 110, host 162 may select the fastest bit rate at which host 162 is capable of communicating, which is the slowest bite rate indicated on the bus. For instance, if temperature sensor 110 attempts to indicate a faster bit rate, the faster bit rate may not be discernable from the bit rate indicated by host 162 so host 162 will select the fastest bit rate at which host 162 is capable of communicating for transmitting the message to temperature sensor 110. In further embodiments, more than one client device may be indicated by address byte 220 and, in several embodiments, host 162 may not be the originating device (originator).

In other embodiments, after transmission of address byte 220, communication speed negotiator 164 may determine an achievable bit rate for host 162 and raise the voltage level on SST bus 170 to a high voltage for one-fourth of that bit rate period. Communication speed negotiator 112 may hold SST bus 170 at a high voltage for one-fourth of an achievable bit rate determined for temperature sensor 110. Communication speed negotiator 164 may monitor SST bus 170 to detect whether the communication speed negotiator 112 has thereby indicated a different bit rate. If so, communication speed negotiator 164 may determine the bit rate indicated by communication speed negotiator 112 and transmit message bytes 240 at that rate. Otherwise, communication speed negotiator 164 may transmit message bytes 240 at the achievable bit rate for host 162.

In alternative embodiments, the addressed client device(s) such as temperature sensor 110 may initiate a speed negotiation for message transmission if the addressed client device(s) are capable of a bit rate that is faster than the bit rate utilized to transmit the address. In such embodiments, the addressed client device(s) may drive SST bus 170 high and the originating device may extend the time at which the bus remains high to negotiate a bit rate for the message.

Once message bytes 240 are transmitted from host 162 to temperature sensor 110, SST bus 170 may be pulled low for a message stop period, t_{STOP}, 250. SST bus 170 may then remain idle 260 until the next communication begins 270, which may be a setup time period, t_{SETUP}, after the end of transmitting message bytes 240.

Bridge 166 may comprise logic including hardware and/or code to transfer communications between bus 190 and SST bus 170. In many embodiments, client devices on SST bus 170 or bus 190 such as temperature sensor 110, voltage sensor 120, microcontroller 130, and digital thermometer 180 may not be aware of bridge 166.

Temperature sensor 110 may comprise a thermal diode to measure the ambient chassis temperature, logic to communicate via SST bus 170, and communication speed negotiator 112. In further embodiments, temperature sensor 110 may comprise other devices to measure other temperatures such as temperatures of devices within a chassis, air flow temperatures in various locations about a chassis, intake air temperatures, outtake air temperatures, and the like. Logic may include hardware and/or code such as processors, state machines, software, firmware, basic input output system (BIOS) code, or the like.

Voltage sensor 120 may comprise a voltage detector and logic to interface SST bus 170 including communication speed negotiator 122. Communication speed negotiator 122 may function similarly to communication speed negotiator 164 and/or 112, depending upon whether communication speed manager 122 is designed to only receive communications or to both receive and initiate communications such as communication 202 of FIG. 2.

Microcontroller 130 may comprise an SST interface by executing code to emulate SST functionality. In some embodiments, for instance, microcontroller 130 may function as a bridge between SST bus 170 and another bus type. Microcontroller 130 comprises communication speed negotiator 132 to negotiate address and message bit rates to receive and/or initiate communications via SST bus 170. Microcontroller 130 couples with SST bus 170 via a “wired-or” connection to potentially allow microcontroller 130 to pull up SST bus 170 while other client devices and/or host 162 pull up and/or weakly pull down SST bus 170.

Digital thermometer 180 may couple with processor 140 to receive digital communications from processor 140 indicating one or more temperatures of substrate in processor 140. Digital thermometer 180 comprises logic to communicate on bus 190 including communication speed negotiator 182. Communication speed negotiator 182 may function similarly to communication speed negotiator 164 and/or 112.

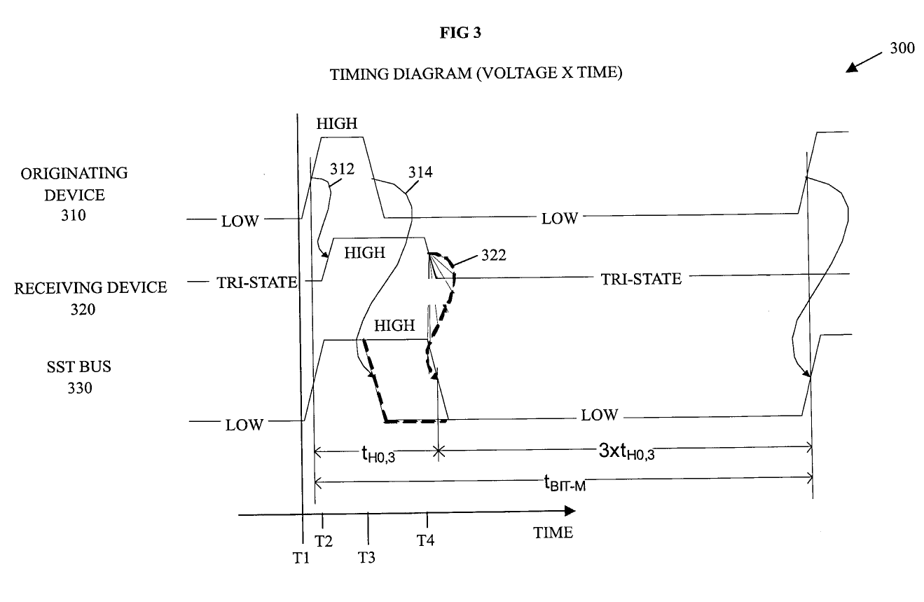

FIG. 3 depicts an embodiment of a timing diagram 300 of bit rate negotiation for a message between an originating device 310 and a receiving device 320 on a SST bus 330. Timing diagram 300 illustrates voltage per time for outputs by originating device 310 and receiving device 320, as well as the resulting voltage on SST bus 330. For instance, in this example, the address byte may have already been transmitted to select receiving device 320 so originating device 310 and receiving device 320 are negotiating to determine the bit rate at which originating device 310 will transmit message bytes to receiving device 320.

Originating device 310 may pull down the output of originating device 310 to pull SST bus 330 low prior to time T1 while receiving device 320 maintains its output in tri-state. Tri-state is a high impedance state, also referred to as “Z-state”, which effectively places a high impedance between receiving device 320 and SST bus 330 to avoid affecting the charge on SST bus 330. Other client devices that are not receiving devices on SST bus 330, if any, may also keep their outputs in tri-state throughout the time period t_{BIT-M}, to avoid affecting the charge on SST bus 330.

At time T1, originating device 310 pulls its output high, which in turn, pulls SST bus 330 high. Originating device 310 holds its output high until time T3, which may be one-forth of the time period for achievable bit rate determined for originating device 310.

In response to originating device 310 pulling SST bus 330 high, receiving device 320 pulls its output high at time T2 if receiving device 320 does not accept the achievable bit rate determined for originating device 310. For instance, if receiving device 320 can operate at the bus' highest speed, receiving device 320 need not pull its output high at time T2. Instead, receiving device 320 just accepts whatever bit rate is indicated on the bus.

After receiving device 320 pulls its output high, receiving device 320 holds its output high until the expiration of a time period t_{HO,3} from the time T1, extending the high voltage level on SST bus 330 from time T3 to time T4, which is one-fourth of the achievable bit rate of receiving device 320. The output of receiving device 320 then returns to tri-state and SST bus 330 goes low as a result of the pull down by the output of originating device 310. Originating device 310 may measure either the extension period from the expected pull down 314 to the actual pull down 322 of SST bus 330 or the total time period t_{HO,3} from the pull up 312 to the pull down 322 of SST bus 330 to determine the bit rate indicated by receiving device 320. In other embodiments, originating device 310 may a substantially equivalent measurement via different reference points.

After receiving the bit rate indication from the receiving device 320, originating device 310 holds SST bus 330 low for the remainder (3xt_{HO,3}) of the indicated bit rate time period t_{BIT-M}. In some embodiments, holding SST bus 330 low for the remainder (3xt_{HO,3}) of the indicated bit rate time period t_{BIT-M} may confirm selection of the bit rate to receiving device 320.

In further embodiments, SST bus 330 may be pulled high for some portion of the indicated bit rate period other than one-fourth. In other embodiments, SST bus 330 may be pulled low for one-fourth of the bit rate period or some other portion of the bit rate period.

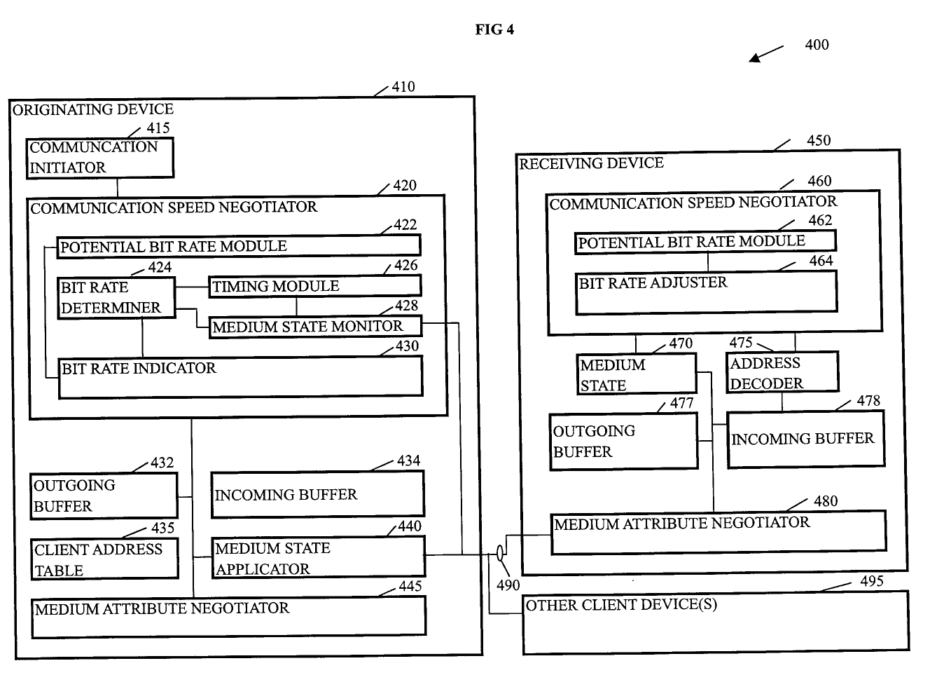

FIG. 4 depicts an embodiment 400 of an originating device 410, a receiving device 450 and other client device(s) 495, each comprising logic to negotiate bit rates for transmission of an address and a message. Originating device 410 may comprise a host or client device communicatively coupled with a communication medium 490. Originating device 410 is capable of initiating a communication with another device on the communication medium 490 such as receiving device 450. Originating device 410 may comprise a communication initiator 415, a communication speed negotiator 420, an outgoing buffer 432, an incoming buffer 434, a client address table 435, a medium state applicator 440, and a medium attribute negotiator 445.

Originating device 410 may determine or be otherwise instructed to transmit a communication to receiving device 450 and communication initiator 415 may determine when communication medium 490 is available to initiate the message. Communication medium 490 may comprise one or more channels for communication via an electrically conductive medium, an optic medium, or other medium over which communications may be transmitted. For instance, medium initiator 415 may wait for a communication via communication medium 490 to complete and then transmit a signal via communication medium 490 to indicate an intention to transmit a message.

Communication speed negotiator 420 may comprise a potential bit rate module 422, a bit rate determiner 424, a timing module 426, a medium state monitor 428, and a bit rate indicator 430. Once communication medium 490 is available to transmit a message and, in some embodiments, after a number of intervening signals, communication speed negotiator 420 may transmit a signal via communication medium 490 to receiving device 450. The signal may initiate a negotiation over a message rate, or bit rate, for transmitting a message such as a command from originating device 410 to receiving device 450. In many embodiments, potential bit rate module 462 of receiving device 450 may transmit via bit rate adjuster 464 and medium state applicator 470 a signal indicative of a bit rate if the rate will be different from a rate indicated by originating device 410. In other embodiments, receiving device 450 may transmit a signal indicative of fastest bit rate that receiving device 450 can support.

In several embodiments, potential bit rate module 422 will select a bit rate for the communication and bit rate indicator 430 may change the state of a message rate signal on communication medium 490 via medium state applicator 440 for a duration of time to indicate the bit rate. Receiving device 450 may respond via a separate message rate signal or by changing or extending the duration of the message rate signal transmitted by originating device 410. In further embodiments, receiving device 450 may not transmit a message rate signal if receiving device 450 will accept the bit rate indicated by originating device 410.

Medium state monitor 428 may identify the change or extension of the message rate signal by receiving device 450 and timing module 426 may associate a time period with the change or extension. Then, bit rate determiner 424 may determine a bit rate associated with the time period. In many embodiments, originating device 410 may determine a bit rate based upon the time period. In some embodiments, communication speed negotiator 420 may select the bit rate indicated by receiving device 450 for the communication. In further embodiments, communication speed negotiator 420 may negotiate another bit rate.

Client address table 435 may comprise a buffer with a list of addresses for receiving device 450 and other client device(s) 495 to address communications to specific devices. Outgoing buffer 432 may store addresses and messages for outgoing signals. In some embodiments, outgoing buffer 432 comprises a queue such as a first-in, first-out (FIFO) queue to store a number of outgoing communications. Once logic such as a software application populates outgoing buffer 432 with a communication, originating device 410 may initiate the communication.

Incoming buffer 434 may store messages received via communication medium 490. For example, when receiving device 450 replies to a communication such as a read command from originating device 410, the reply or part thereof may be stored in incoming buffer 434. Then logic such as a software application may read the reply from incoming buffer 434.

Medium attribute negotiator 445 may negotiate attributes for the communication medium 490 during transmission of the message based upon capabilities of originating device 410. In some embodiments, medium attribute negotiator 445 may negotiate attributes for the communication medium 490 based upon capabilities associated with receiving device 450. For instance, if the communication medium 490 is a wire bus for electrical signals, medium attribute negotiator 445 may negotiate electrical characteristics or attributes such as voltage ranges associated with bits of data, time frames associated with a voltage level for indication of bits, and the like. In further embodiments, if the medium is an optical fiber, air, or other medium for conducting light, medium attribute negotiator 445 may negotiate optical characteristics or attributes such as light intensity associated with bits of data, time frames associated with a light intensity for indication of bits, and the like. For example, for an optical fiber bus, the wired-or connection may be an interconnection with two or more potential sources of light and raising the voltage to a high level may be equivalent to directing a light with a predetermined intensity into an optical fiber. In such embodiments, for example, speed negotiation may involve measuring the length of time for which the light intensity or a range thereof is directed through the optical fiber. Furthermore, medium attribute negotiator 445 may initiate negotiation of the medium attributes and/or be responsive to a negotiation initiated by receiving device 450.

Receiving device 450 may comprise a communication speed negotiator 460, a medium state applicator 470, an address decoder 475, an outgoing buffer 477, an incoming buffer 478, and a medium attribute negotiator 480. Communication speed negotiator 460 may negotiate selection of a bit rate for communication with originating device 410 based upon capabilities of receiving device 450. Communication speed negotiator 460 may comprise a potential bit rate module 462 and a bit rate adjuster 464. Potential bit rate module 462 may determine the capabilities of receiving device 450 and, in some embodiments, may take into account current circumstances to the extent that the current circumstances can affect the bit rate at which receiving device 450 can communicate. Current circumstances may comprise, for instance, a current operating temperature, ambient temperature, an availability for processing other operations, a priority associated with the communication and/or other operations, and the like.

Bit rate adjuster 464 may comprise logic to adjust or extend a message rate signal transmitted via communication medium 490 by originating device 410, which is indicative of a bit rate selected by originating device 410. Bit rate adjuster 464 may adjust or extend a message rate signal by modifying or maintaining the state of the signal on communication medium 490 via medium state applicator 470. By adjusting or extending the message rate signal, bit rate adjuster 464 may indicate an alternative bit rate.

Outgoing buffer 477 may store addresses and messages for outgoing signals. In some embodiments, outgoing buffer 477 comprises a queue such as a first-in, first-out (FIFO) queue to store a number of outgoing communications. Once logic such as a microcode populates outgoing buffer 477 with a communication such as a response for a command transmitted from originating device 410, receiving device 450 may initiate transmission of the communication.

Incoming buffer 478 may store messages addressed to receiving device 450 received via communication medium 490. For example, when originating device 410 transmits a communication such as a read command to receiving device 450, the communication or part thereof may be stored in incoming buffer 478. Then logic such as microcode may read the command from incoming buffer 478 and respond accordingly.

Address decoder 475 may be logic to determine whether a communication is directed toward receiving device 450. In particular, address decoder 475 may monitor communication medium 490 to identify an address of a communication that is associated with the address of receiving device 450. Upon identifying such an address, address decoder 475 may activate communication speed negotiator 460 and, in several embodiments, medium attribute negotiator 480. In further embodiments, address decoder 475 may monitor communication medium 490 via incoming buffer 478.

Medium attribute negotiator 480 may comprise logic to negotiate attributes of communication medium 490 with originating device 410 via medium state applicator 470. In some embodiments, medium attribute negotiator 480 may maintain data that indicates capabilities of receiving device 450 in relation to medium attributes, and, in many embodiments, medium attribute negotiator 480 may maintain data related to capabilities of communication medium 490.

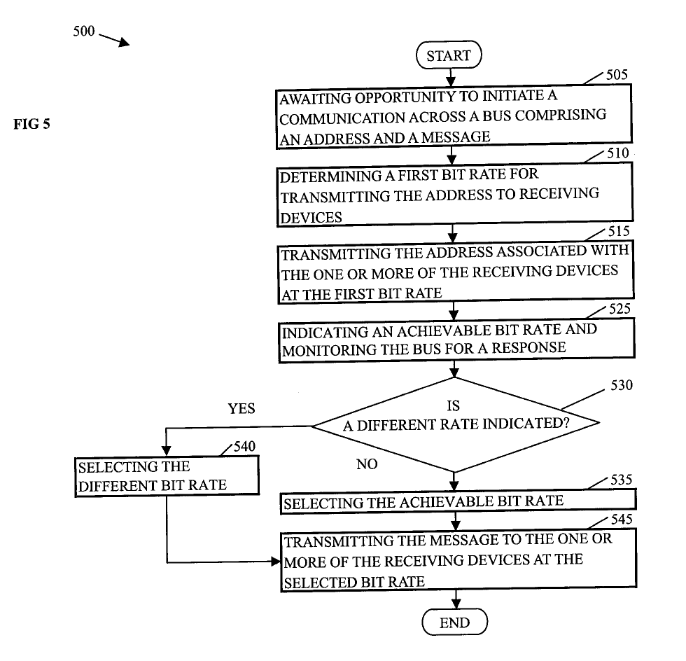

FIG. 5 depicts a flowchart 500 of an embodiment for an originating device to negotiate a message bit rate with one or more receiving devices. Flowchart 500 begins with awaiting opportunity to initiate a communication across a bus comprising an address and a message (element 505). For instance, the originating device may wait for a communication to terminate or simply note that the bus is idle and wait for a specified setup time to elapse before asserting control over the bus. In some embodiments, assertion of control over the bus may be a race with other devices capable of asserting control over the bus. In other embodiments, assertion of control may be offered in a round-robin manner and/or based upon one or more priority levels associated with the communication and/or the originating device.

Upon asserting control over the bus, the originating device may determine a first bit rate for transmitting the address to one or more receiving devices (element 510). For example, in some embodiments, a default or otherwise pre-selected bit rate may be set for the bus for transmitting address bytes across the bus. In further embodiments, such as embodiments that facilitate hot plugging of client devices onto the bus, the bit rate for transmission of the address byte may be negotiated between the originating device and client devices coupled with the bus.

The originating device may then transmit the address associated with the one or more targeted client devices, or receiving devices, at that first bit rate (element 515). The first bit rate may facilitate communications with the slowest client devices on the bus. The originating device may then transmit a message rate signal to indicate an achievable bit rate and monitor the bus to determine whether the one or more receiving devices respond with a different bit rate (element 525). For example, the one or more receiving devices selected via the transmission of the address may respond to the indication of a different bit rate when at least one receiving device is not capable of communicating at the achievable bit rate proposed by the originating device. The one or more receiving devices may respond by maintaining a logic bit level on the bus for a time period beyond which the originating device maintains logic bit level to indicate the different it rate. The logic bit level may be, e.g., a voltage level associated with transmission of a signal indicative of a bit for electrical signal media. The originating device may then drive the bus low for a period of time to select the different bit rate (element 540) and transmit the message to the one or more receiving devices at that selected bit rate (element 545). In other embodiments, the originating device may select the bit rate for the message based upon the length of time associated with the logic bit level without driving the bus low.

On the other hand, if the originating device does not detect the different bit rate (element 530), the originating device may select the achievable bit rate (element 535) and transmit the message to the one or more receiving devices at the achievable bit rate (element 545). In further embodiments, the bus may comprise communication medium other than a communication medium for electrical signals.

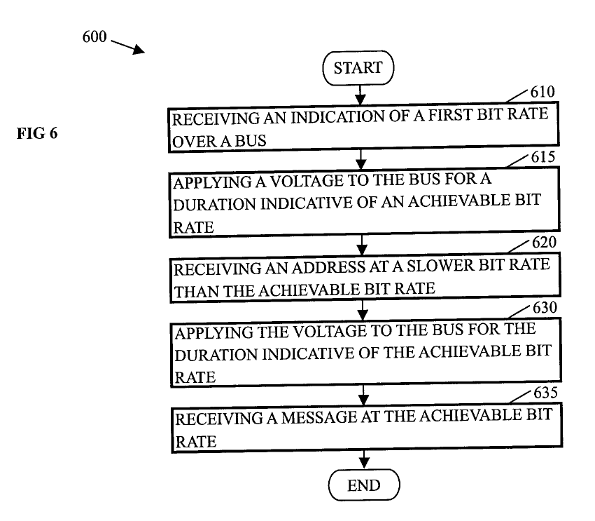

FIG. 6 depicts a flowchart 600 of an embodiment for a receiving device to negotiate a message bit rate with an originating device. Flowchart 600 begins with receiving an indication of a first bit rate over a bus (element 610). For example, the receiving device may, e.g., monitor the bus for communications and, upon receipt of the indication of the first bit rate, respond with a signal indicative of an alternative, achievable bit rate if the receiving device is not capable of communicating at the first bit rate.

In response to the indication of the first bit rate, receiving device may apply a voltage to or otherwise maintain the voltage on the bus for a duration indicative of the achievable bit rate (element 615). In some embodiments, after indicating the achievable bit rate, the receiving device may receive a confirmation that the achievable bit rate or a slower bit rate has been selected.

The receiving device may then receive an address at a slower bit rate than the achievable bit rate (element 620). For instance, if other client devices on the bus cannot communicate at the achievable bit rate for the receiving device, then the originating device, for example, may select a slower bit rate.

After receiving the address, the receiving device may decode the address to determine that the receiving device is a targeted client device for the following message. In some embodiments, the receiving device may then receive an indication initiating re-negotiation of the slow bit rate. For instance, the originating device may initiate a second speed negotiation for the message to determine whether the message can be transmitted at a rate faster than the bit rate at which the address was transmitted. In further embodiments, the originating device may indicate a bit rate other than the slow bit rate.

The receiving device may respond by applying a voltage to or otherwise maintaining the voltage on the bus for a period of time indicative of the achievable bit rate (element 630). For example, the receiving device may still be capable of receiving at the achievable bit rate whether or not the achievable bit rate was selected for transmission of the address.

After negotiating the message bit rate, the receiving device may receive the message at the achievable bit rate (element 635). In some situations, more than one client device may be selected by the address so a bit rate slower than the achievable bit rate may be selected if not all the receiving devices will be capable of communicating at the achievable bit rate.

Another embodiment of the invention is implemented as a program product for use with a system to perform processes such as the processes described in conjunction with system 100 as illustrated in FIG. 1 or other embodiments described in FIGS. 2-6. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., a Universal Serial Bus (USB) flash drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates systems and arrangements to negotiate a communication speed. It is understood that the form of the invention shown and described in the detailed description and the drawings are to be taken merely as examples. It is intended that the following claims be interpreted broadly to embrace all the variations of the embodiments disclosed.

Although some embodiments of the present invention have been described in detail, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A device for negotiation of a communication speed, the device comprising:
a medium state monitor to monitor a message rate signal on a medium after transmission of an address of a communication, wherein the communication comprises the address and a message; and
a bit rate determiner coupled with the medium state monitor to determine a message bit rate associated with the message.

2. The device of claim 1, further comprising a timing module coupled with the medium state monitor to determine a period of time associated with the message rate signal.

3. The device of claim 2, wherein the bit rate determiner is to determine the message bit rate based upon the period of time.

4. The device of claim 1, further comprising a medium state applicator to transmit the message at the message bit rate.

5. The device of claim 1, further comprising a medium attribute negotiator to communicate with another device to determine a medium attribute to change for the medium for transmission of the message.

6. The device of claim 5, wherein the medium attribute comprises an electrical characteristic associated with communication via the medium, wherein the electrical characteristic can comprise a time range associated with a logical one and a time range associated with a logical zero.

7. The device of claim 5, wherein the medium attribute comprises an optical characteristic associated with communication via the medium, wherein the optical characteristic can comprise ranges of time associated with bits.

8. A device to negotiate a communication speed, the device comprising:
a medium state applicator to drive a message rate signal on a medium after transmission of an address of a communication, wherein the communication comprises the address and a message; and
a speed negotiator to determine the message rate signal, wherein the message rate signal is indicative of a message bit rate.

9. The device of claim 8, wherein the speed negotiator comprises logic to detect an alternative rate signal on the medium.

10. The device of claim 8, wherein the speed negotiator comprises a bit rate indicator coupled with the medium state applicator to determine changes in state for the medium to transmit the message rate signal.

11. The device of claim 8, wherein the speed negotiator comprises logic to extend an alternative rate signal via the medium state applicator to create the message rate signal.

12. The device of claim 8, wherein the speed negotiator comprises a potential bit rate module to determine the message bit rate, wherein the message bit rate is a fastest achievable bit rate by the device to receive a transmission of the message.

13. A method to negotiate a communication speed, the method comprising:
transmitting, by an originating device, an address at a first bit rate to at least one target device via a medium;
monitoring the transmission medium for a first signal indicative of an alternative bit rate from the at least one target device; and
determining a message bit rate based upon the monitoring.

14. The method of claim 13, further comprising transmitting another signal and monitoring for a response to the other signal to determine the first bit rate.

15. The method of claim 13, further comprising detecting a second signal indicative of a medium attribute and communicating via the medium in accordance with the medium attribute.

16. The method of claim 13, further comprising determining a potential bit rate and transmitting a message rate signal indicative of the potential bit rate.

17. The method of claim 16, wherein determining the message bit rate comprises selecting the potential bit rate in the absence of the alternative bit rate.

18. The method of claim 13, wherein monitoring the transmission medium comprises measuring a duration of the first signal to calculate the message bit rate, wherein the first signal comprises an extension of a message rate signal initiated by the originating device.

19. The method of claim 13, wherein monitoring the transmission medium comprises monitoring the medium for an indication of a medium attribute.

20. The method of claim 13, wherein determining the message bit rate comprises selecting the alternative bit rate in response to detection of the alternative bit rate.

21. A system for negotiating a communication speed, the system comprising:
a host device to manage a communication medium;
a client device comprising a medium state applicator to transmit a message rate signal via the communication medium after transmission of an address of a communication, wherein the communication comprises the address and a message; and a speed negotiator to determine the message rate signal, wherein the message rate signal is indicative of a message bit rate; and
dynamic random access memory coupled with the host device.

22. The system of claim 21, wherein the host device comprises a communication speed negotiator to drive the communication medium with another message rate signal after transmission of another address of another communication.

23. The system of claim 21, wherein the client device comprises a medium state monitor to monitor the medium for an alternative rate signal.

24. The system of claim 23, wherein the client device comprises a timing module coupled with the medium state monitor to determine a period of time associated with the alternative rate signal.

25. The system of claim 23, wherein the client device comprises a bit rate determiner coupled with the medium state monitor to determine an alternative rate associated with the alternative rate signal.

26. The system of claim 21, wherein the client device comprises a medium attribute negotiator to communicate with another device to determine a medium attribute to change for the medium during transmission of the message.

27. The system of claim 21, wherein the dynamic random access memory is coupled with the host device via a memory controller hub.

28. A machine-accessible medium containing instructions, which when executed by a storage device, cause the storage device to perform operations, the operations comprising:
transmitting, by an originating device, an address at a first bit rate to at least one target device via a medium;
monitoring the transmission medium for a first signal indicative of an alternative bit rate from the at least one target device; and
determining a message bit rate based upon the monitoring.

29. The machine-accessible medium of claim 28, wherein the operations further comprise transmitting a message rate signal, wherein the first signal comprises extension of the message rate signal.

30. The machine-accessible medium of claim 28, wherein the operations further comprise detecting a third signal indicative of a medium attribute and communicating via the medium in accordance with the medium attribute.
